(19) United States
(12) Patent Application Publication
(10) Pub. No.: US 2014/0068019 A1
(43) Pub. Date: Mar. 6, 2014

(54) TECHNIQUES AND METHODS FOR ARCHIVING AND TRANSMITTING DATA HOSTED ON A SERVER

(71) Applicants: TRIPTI SHETH, Fremont, CA (US); STEVEN LAWRANCE, San Francisco, CA (US); KRIS BOTHA, San Francisco, CA (US)

(72) Inventors: TRIPTI SHETH, Fremont, CA (US); STEVEN LAWRANCE, San Francisco, CA (US); KRIS BOTHA, San Francisco, CA (US)

(21) Appl. No.: 14/017,145

(22) Filed: Sep. 3, 2013

Related U.S. Application Data
(60) Provisional application No. 61/696,594, filed on Sep. 4, 2012.

(51) Int. Cl. H04L 29/08

(52) U.S. Cl. CPC H04L 67/06
USPC 709/219

(57) ABSTRACT

Techniques for transmitting and archiving data hosted on a server. A collection of data is generated, in response to a request, that includes at least a first portion of user content and a second portion of metadata. The collection of data is transmitted as a file.

### PRIORITY AND RELATED APPLICATION DATA

This application claims priority to Provisional U.S. Patent App. No. 61/696,594, filed on Sep. 4, 2012, entitled “System and Method for Data in Handling Data in a Remote On-Demand Database,” which is incorporated herein by reference in its entirety and for all purposes.

### TECHNICAL FIELD

Embodiments relate to data archival and/or transmission. More specifically, embodiments relate to techniques to provide a more useful and efficient results from one or more database operations.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

With prevalence of cloud computing, users are seeking ways to manage content stored in the cloud. Moreover, creative ways to manipulate data stored in the cloud and using the results those manipulations at another locations are desired.

Conventional methods of handling data stored in the cloud are very limited in their operability. Traditionally, users do not have the same freedom in terms of manipulating data stored in the cloud as they have in local storage devices. Content management systems that are cloud based like Site.com provide users with features to communicate between the cloud and local system. However, they still lack processes that provide efficient utility and operability on the data stored in the cloud.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a system in which the technology disclosed herein may be utilized.

FIG. 2 is one embodiment of a flow diagram for providing an archival file to a requesting device.

FIG. 3 is a block diagram of one embodiment of an electronic system.

FIG. 4 illustrates a block diagram of an environment where an on-demand database service might be used.

FIG. 5 illustrates a block diagram of an environment where an on-demand database service might be used.

FIG. 6 is a block diagram of one embodiment of an agent that may be utilized to support creation of copies of structured data (e.g., websites) as described herein.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Given the shortcomings discussed above, an opportunity arises to provide users with tools that will allows them to use the data stored in the cloud for greater scalability, management and performance. The technology disclosed relates to handling data in a remote on-demand database, and more particularly to techniques for managing and handling website archives stored in a cloud for the purposes of backups, staging, testing, diagnostics, as well as upgrade and migration development.

Cloud based content management systems (e.g., Site.com) allow users to create and edit dynamic websites. The website data including stylesheets, assets, etc. Once created the data for the dynamic websites can be stored in various databases, for example, by a remote on-demand system.

In one implementation, the technology disclosed herein allows user to take the entirety of data belonging to a given site, and download or export it as an executable file. In one embodiment, this executable file can be partially encrypted, where the first segment of the file can be text-readable, while the second segment of the file can be an encrypted blob containing various data and dependencies required to construct the site. With this implementation, a user can also download this file to their local storage such as a hard-drive and become its owner. Hence, this can allow users to use it data for purposes such as re-creating or importing their site files to cloud based content management systems.

In another implementation, users can make an off-site or local backup of a website containing all dependencies in terms of references to images, files and other content. In this implementation, the users can take a snapshot or clone an existing site, transfer work between organizations or teams, create untouchable or locked templates for future site development work.

In another implementation, the technology disclosed herein can be used for stress testing purposes that involve creating large websites containing large data, logic and dependencies. This website data can then be exported as an executable file used for further testing. In another implementation, the technology disclosed herein can be used for migration of data that involves loading executable files to an on-demand remote system to verifying that the migration logic for sites runs as expected.

In yet another implementation, the technology disclosed herein can be used for upgrading purposes that involves making opaque backups of customer sites, importing them into staging environments and verifying that the output matches the public view. In one embodiment, the file formats can only be part-encrypted and the web developers can take the first section of the file to allow the end users to make modifications locally, which can be reflected in the remote database upon export.

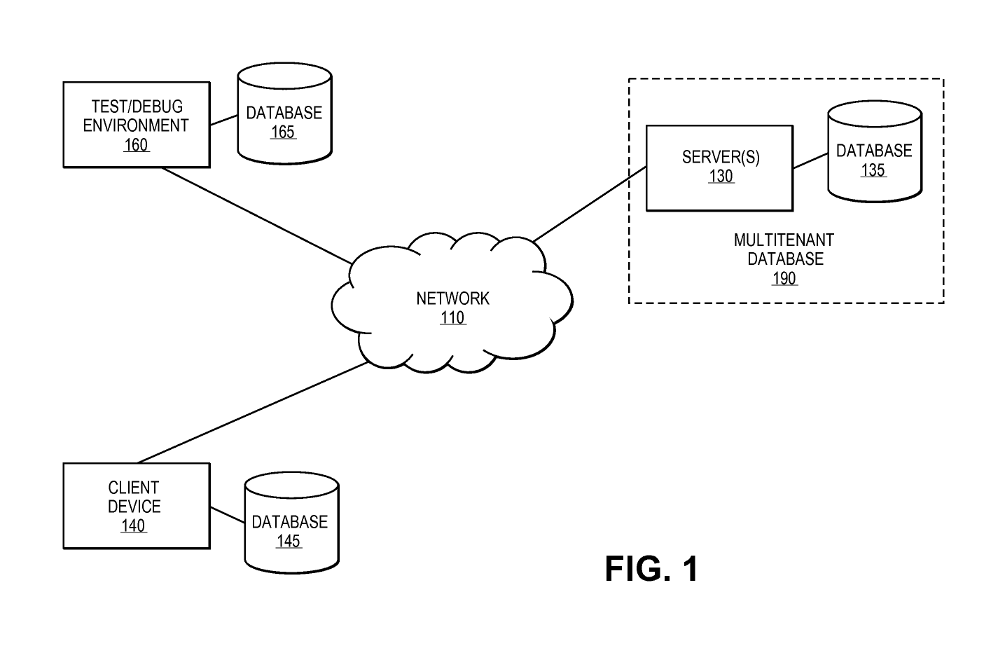

FIG. 1 is a block diagram of one embodiment of a system in which the technology disclosed herein may be utilized. Network 110 can be any type of interconnection between multiple computing devices, whether wired or wireless or a combination thereof. For example, network 110 can be a local area network (LAN), the Internet, a personal area network (PAN), or any other type of network, or any combination thereof.

Client device 140 allows a user to access data stored on server(s) 130 as well as other devices coupled with network 110. In one embodiment, server(s) 130 may be part of multitenant database system 190. Embodiments of multitenant database systems are described in greater detail below. In one embodiment, server(s) 130 may provide access to a website (or other structured data) that is stored in database 135. A user may access the website via client device 140.

In one embodiment, a user may create a copy of the website to be stored in database 145, which is coupled with client device 140. In response to the request, server(s) 130 may generate a copy of the website as a single file to be transmitted to client device 140. In one embodiment, the copy of the website can be transmitted to test/debug environment 160 and/or stored in database 165. Test/debug environment 160 can be part of multitenant database environment 190 or can be independent of multitenant database environment 190.

In one embodiment, when a user requests a copy of a website (or other structured data) that is hosted by server(s) 130 and/or database 135 via client device 140, server(s) 130 create a data file that includes content for the website as well as organizational/formatting/backend/etc. data that makes the content functional. In one embodiment, some or all of the content is not encrypted while some or all of the content as well as the organizational/formatting/backend/etc. data are encrypted. Thus, the resulting file can be partially encrypted.

In one embodiment, the encrypted portion of the file includes information that allows server(s) 130 to utilize the content to generate a website. That is, the non-content portions of the file can be encrypted. Thus, without the proper decryption information, the file corresponding to the website cannot be used to provide the website outside of server(s) 130.

In one embodiment test/debug environment 160 has access to decryption credentials so that the file corresponding to the website can be tested and/or debugged without running on server(s) 130. For example, a website can be taken down from server(s) 130 and transmitted to test/debug environment 160. Within test/debug environment 160, the file can be tested and debugged, then returned to server(s) 130 or client device 140.

The example of illustrating the use of technology disclosed herein though executable files and cloud-based systems should not be taken as limiting or preferred. This example sufficiently illustrates the technology disclosed without being overly complicated. It is not intended to illustrate all of the technologies disclosed.

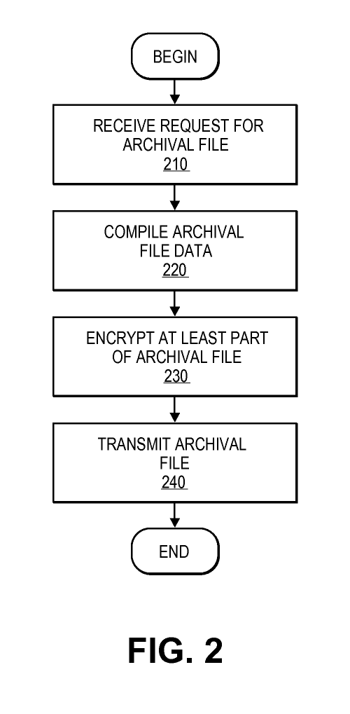

FIG. 2 is one embodiment of a flow diagram for providing an archival file to a requesting device. The process of FIG. 2 is described in terms of the operation of one or more servers (e.g., server(s) 130 in FIG. 1) with counterpart operations performed by other devices (e.g., client device 140 in FIG. 1).

A request for an archival file is received, 210. In one embodiment, a user may have access to a graphical user interface that includes the ability to request a copy of, for example, a website hosted by the server. In one embodiment, a user may select from a menu or a window and option such as “duplicate” or “archive” to generate the request. In one embodiment, the server or other device receiving the request may determine whether the requestor has sufficient authority to request the copy. If not, the request may be denied.

The archival file is compiled, 220. In one embodiment, one or more servers (e.g., within a multitenant database environment) can compile the file, which includes the content that a user may access when using the website as well as logic, structures, background data, metadata, and other data used to make the website functional, some of which may be confidential and/or proprietary. In one embodiment, the archival file is an executable file.

In one embodiment, one or more of the following data types (and uses) can be included in a binary format within the archival file. Additional and/or different data types can also be included in the archival file.

Page and page template objects
Page component objects

Static content blocks

Script code blocks

Image references

Dynamic data elements (e.g., repeaters, data tables, data functions)

Forms

Navigation objects (e.g., menus, bread crumbs, language switchers)

File and folder assets (e.g., images)
By-reference widgets that can be reused
Data connections that specify metadata (e.g., authentication, object information)
IP restriction rules
URL redirect rules
Site configuration settings (e.g., error, home, not-found pages)
Roles assigned to users
Languages and translations defined for content

At least a portion of the archival file is encrypted, 230. In one embodiment, the content portion of the file is not encrypted while the remainder of the file is encrypted. In alternate embodiments, other configurations may be used. For example, the whole file may be encrypted or a portion of the content may be encrypted. In one embodiment, the non-encrypted portion of the file include an executable element so that the archival file is an executable file. The executable portion may provide the functionality to access the encrypted portion with the proper credentials.

The archival file is transmitted, 240. In one embodiment, the file is transmitted to the requesting device. In an alternate embodiment, the file may be transmitted to a different destination as determined by the request.

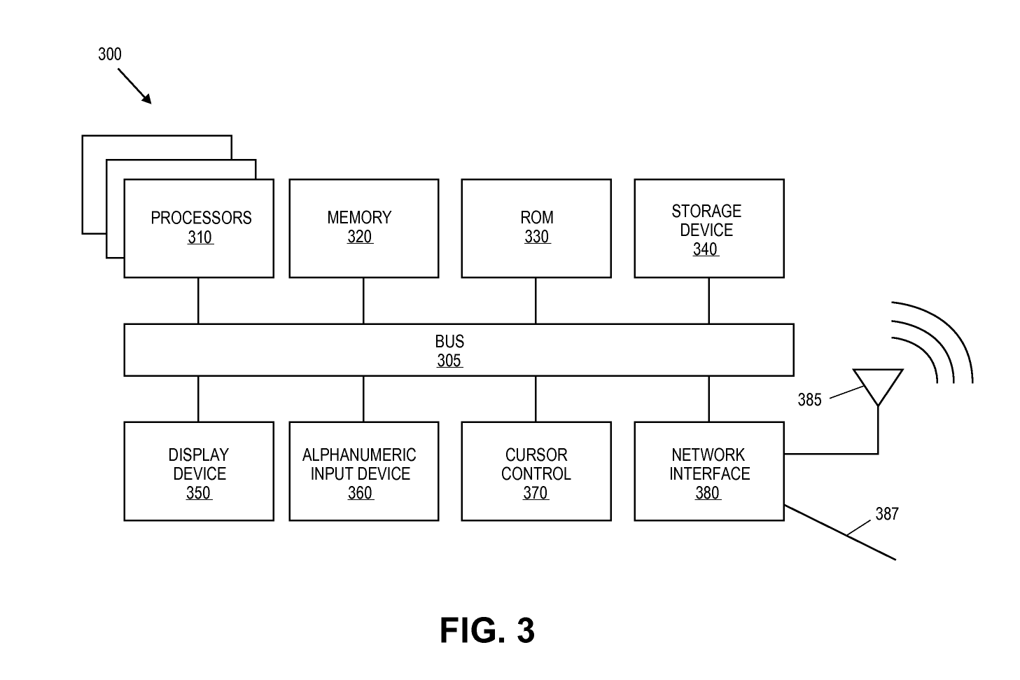

FIG. 3 is a block diagram of one embodiment of an electronic system. The electronic system illustrated in FIG. 3 is intended to represent a range of electronic systems (either wired or wireless) including, for example, desktop computer systems, laptop computer systems, cellular telephones, personal digital assistants (PDAs) including cellular-enabled PDAs, set top boxes, tablets, etc. Alternative electronic systems may include more, fewer and/or different components.

Electronic system 300 includes bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as main memory), coupled to bus 305 and may store information and instructions that may be executed by processor 310. Main memory 320 may also be used to store temporary variables or other intermediate information during execution of instructions by processor 310.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a cathode ray tube (CRT) or liquid crystal display (LCD), to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display 350.

Electronic system 300 further may include network interface(s) 380 to provide access to a network, such as a local area network. Network interface(s) 380 may include, for example, a wireless network interface having antenna 385, which may represent one or more antenna(e). Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 380 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

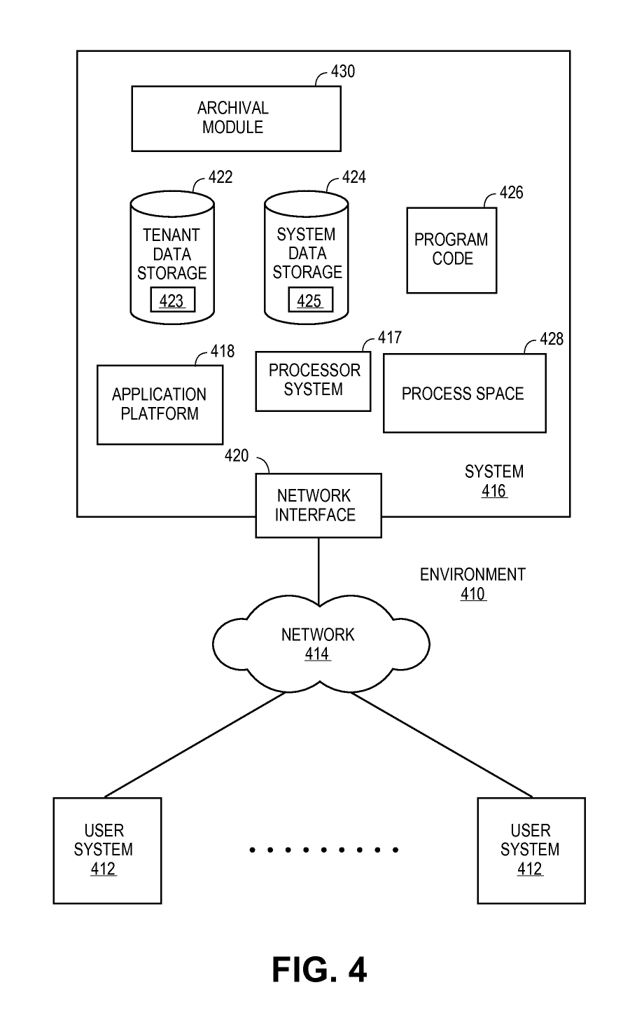

FIG. 4 illustrates a block diagram of an environment 410 wherein an on-demand database service might be used. The query techniques and mechanisms described herein may be utilized in an on-demand, or multitenant, database environment. Environment 410 may include user systems 412, network 414, system 416, processor system 417, application platform 418, network interface 420, tenant data storage 422, system data storage 424, program code 426, and process space 428. In other embodiments, environment 410 may not have all of the components listed and/or may have other elements instead of, or in addition to, those listed above.

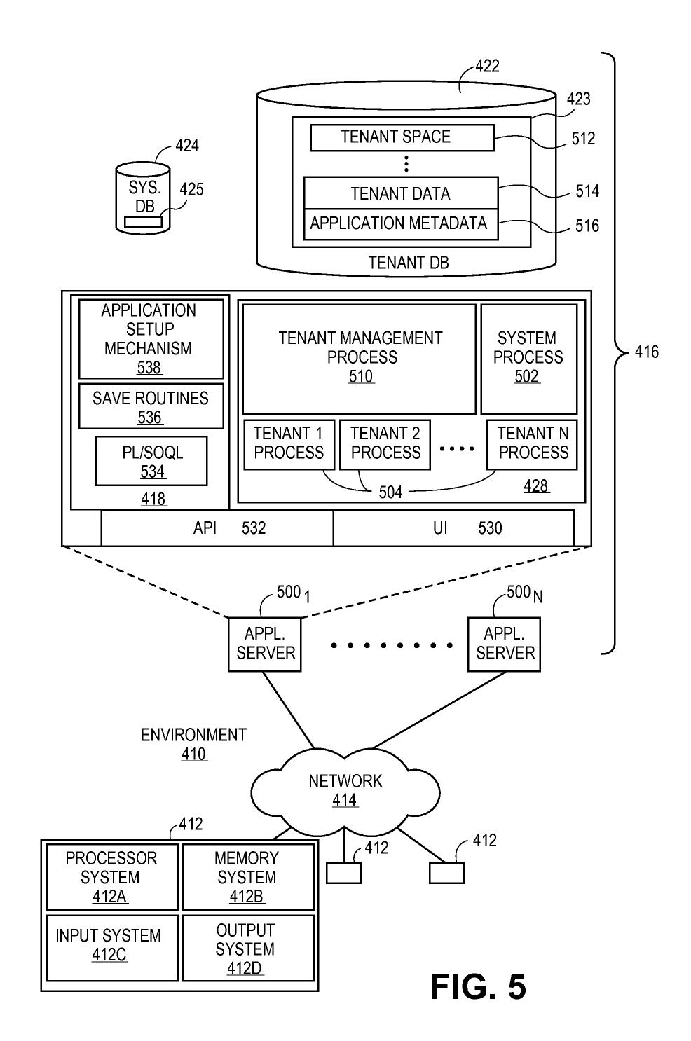

Environment 410 is an environment in which an on-demand database service exists. User system 412 may be any machine or system that is used by a user to access a database user system. For example, any of user systems 412 can be a handheld computing device, a mobile phone, a laptop computer, a work station, and/or a network of computing devices. As illustrated in FIG. 4 (and in more detail in FIG. 5) user systems 412 might interact via a network 414 with an on-demand database service, which is system 416.

An on-demand database service, such as system 416, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 416” and “system 416” will be used interchangeably herein.

A database image may include one or more database objects. A relational database management system (RDMS) or the equivalent may execute storage and retrieval of information against the database object(s). Application platform 418 may be a framework that allows the applications of system 416 to run, such as the hardware and/or software, e.g., the operating system. In an embodiment, on-demand database service 416 may include an application platform 418 that enables creation, managing and executing one or more applications developed by the provider of the on-demand database service, users accessing the on-demand database service via user systems 412, or third party application developers accessing the on-demand database service via user systems 412.

The users of user systems 412 may differ in their respective capacities, and the capacity of a particular user system 412 might be entirely determined by permissions (permission levels) for the current user. For example, where a salesperson is using a particular user system 412 to interact with system 416, that user system has the capacities allotted to that salesperson. However, while an administrator is using that user system to interact with system 416, that user system has the capacities allotted to that administrator.

In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 414 is any network or combination of networks of devices that communicate with one another. For example, network 414 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 412 might communicate with system 416 using TCP/IP and, at a higher network level, use other common Internet protocols to communicate, such as HTTP, FTP, AFS, WAP, etc. In an example where HTTP is used, user system 412 might include an HTTP client commonly referred to as a “browser” for sending and receiving HTTP messages to and from an HTTP server at system 416. Such an HTTP server might be implemented as the sole network interface between system 416 and network 414, but other techniques might be used as well or instead. In some implementations, the interface between system 416 and network 414 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 416, shown in FIG. 4, implements a web-based customer relationship management (CRM) system. For example, in one embodiment, system 416 includes application servers configured to implement and execute CRM software applications as well as provide related data, code, forms, webpages and other information to and from user systems 412 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared.

In certain embodiments, system 416 implements applications other than, or in addition to, a CRM application. For example, system 416 may provide tenant access to multiple hosted (standard and custom) applications, including a CRM application. User (or third party developer) applications, which may or may not include CRM, may be supported by the application platform 418, which manages creation, storage of the applications into one or more database objects and executing of the applications in a virtual machine in the process space of the system 416.

One arrangement for elements of system 416 is shown in FIG. 4, including a network interface 420, application platform 418, tenant data storage 422 for tenant data 423, system data storage 424 for system data 425 accessible to system 416 and possibly multiple tenants, program code 426 for implementing various functions of system 416, and a process space 428 for executing MTS system processes and tenant-specific processes, such as running applications as part of an application hosting service. Additional processes that may execute on system 416 include database indexing processes.

Several elements in the system shown in FIG. 4 include conventional, well-known elements that are explained only briefly here. For example, each user system 412 could include a desktop personal computer, workstation, laptop, PDA, cell phone, or any wireless access protocol (WAP) enabled device or any other computing device capable of interfacing directly or indirectly to the Internet or other network connection. User system 412 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 412 to access, process and view information, pages and applications available to it from system 416 over network 414.

Each user system 412 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 416 or other systems or servers. For example, the user interface device can be used to access data and applications hosted by system 416, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 412 and all of its components are operator configurable using applications, such as a browser, including computer code run using a central processing unit such as an Intel Pentium® processor or the like. Similarly, system 416 (and additional instances of an MTS, where more than one is present) and all of their components might be operator configurable using application(s) including computer code to run using a central processing unit such as processor system 417, which may include an Intel Pentium® processor or the like, and/or multiple processor units.

A computer program product embodiment includes a machine-readable storage medium (media) having instructions stored thereon/in which can be used to program a computer to perform any of the processes of the embodiments described herein. Computer code for operating and configuring system 416 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 416 is configured to provide webpages, forms, applications, data and media content to user (client) systems 412 to support the access by user systems 412 as tenants of system 416. As such, system 416 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B).

As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 5 also illustrates environment 410. However, in FIG. 5 elements of system 416 and various interconnections in an embodiment are further illustrated. FIG. 5 shows that user system 412 may include processor system 412A, memory system 412B, input system 412C, and output system 412D. FIG. 5 shows network 414 and system 416. FIG. 5 also shows that system 416 may include tenant data storage 422, tenant data 423, system data storage 424, system data 425, User Interface (UI) 530, Application Program Interface (API) 532, PL/SOQL 534, save routines 536, application setup mechanism 538, applications servers 500₁-500_{N}, system process space 502, tenant process spaces 504, tenant management process space 510, tenant storage area 512, user storage 514, and application metadata 516. In other embodiments, environment 410 may not have the same elements as those listed above and/or may have other elements instead of, or in addition to, those listed above.

User system 412, network 414, system 416, tenant data storage 422, and system data storage 424 were discussed above in FIG. 4. Regarding user system 412, processor system 412A may be any combination of one or more processors. Memory system 412B may be any combination of one or more memory devices, short term, and/or long term memory. Input system 412C may be any combination of input devices, such as one or more keyboards, mice, trackballs, scanners, cameras, and/or interfaces to networks. Output system 412D may be any combination of output devices, such as one or more monitors, printers, and/or interfaces to networks.

As shown by FIG. 5, system 416 may include a network interface 420 (of FIG. 4) implemented as a set of HTTP application servers 500, an application platform 418, tenant data storage 422, and system data storage 424. Also shown is system process space 502, including individual tenant process spaces 504 and a tenant management process space 510. Each application server 500 may be configured to tenant data storage 422 and the tenant data 423 therein, and system data storage 424 and the system data 425 therein to serve requests of user systems 412. The tenant data 423 might be divided into individual tenant storage areas 512, which can be either a physical arrangement and/or a logical arrangement of data.

Within each tenant storage area 512, user storage 514 and application metadata 516 might be similarly allocated for each user. For example, a copy of a user's most recently used (MRU) items might be stored to user storage 514. Similarly, a copy of MRU items for an entire organization that is a tenant might be stored to tenant storage area 512. A UI 530 provides a user interface and an API 532 provides an application programmer interface to system 416 resident processes to users and/or developers at user systems 412. The tenant data and the system data may be stored in various databases, such as one or more Oracle™ databases.

Application platform 418 includes an application setup mechanism 538 that supports application developers' creation and management of applications, which may be saved as metadata into tenant data storage 422 by save routines 536 for execution by subscribers as one or more tenant process spaces 504 managed by tenant management process 510 for example. Invocations to such applications may be coded using PL/SOQL 534 that provides a programming language style interface extension to API 532.

A detailed description of some PL/SOQL language embodiments is discussed in commonly owned co-pending U.S. Provisional Patent Application 40/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 516 for the subscriber making the invocation and executing the metadata as an application in a virtual machine.

Each application server 500 may be communicably coupled to database systems, e.g., having access to system data 425 and tenant data 423, via a different network connection. For example, one application server 500₁ might be coupled via the network 414 (e.g., the Internet), another application server 500_{N-1} might be coupled via a direct network link, and another application server 500_{N} might be coupled by yet a different network connection. Transfer Control Protocol and Internet Protocol (TCP/IP) are typical protocols for communicating between application servers 500 and the database system. However, it will be apparent to one skilled in the art that other transport protocols may be used to optimize the system depending on the network interconnect used.

In certain embodiments, each application server 500 is configured to handle requests for any user associated with any organization that is a tenant. Because it is desirable to be able to add and remove application servers from the server pool at any time for any reason, there is preferably no server affinity for a user and/or organization to a specific application server 500. In one embodiment, therefore, an interface system implementing a load balancing function (e.g., an F5 Big-IP load balancer) is communicably coupled between the application servers 500 and the user systems 412 to distribute requests to the application servers 500.

In one embodiment, the load balancer uses a least connections algorithm to route user requests to the application servers 500. Other examples of load balancing algorithms, such as round robin and observed response time, also can be used. For example, in certain embodiments, three consecutive requests from the same user could hit three different application servers 500, and three requests from different users could hit the same application server 500. In this manner, system 416 is multi-tenant, wherein system 416 handles storage of, and access to, different objects, data and applications across disparate users and organizations.

As an example of storage, one tenant might be a company that employs a sales force where each salesperson uses system 416 to manage their sales process. Thus, a user might maintain contact data, leads data, customer follow-up data, performance data, goals and progress data, etc., all applicable to that user's personal sales process (e.g., in tenant data storage 422). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 416 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 416 might also maintain system level data usable by multiple tenants or other data. Such system level data might include industry reports, news, postings, and the like that are sharable among tenants.

In certain embodiments, user systems 412 (which may be client systems) communicate with application servers 500 to request and update system-level and tenant-level data from system 416 that may require sending one or more queries to tenant data storage 422 and/or system data storage 424. System 416 (e.g., an application server 500 in system 416) automatically generates one or more SQL statements (e.g., one or more SQL queries) that are designed to access the desired information. System data storage 424 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields.

For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

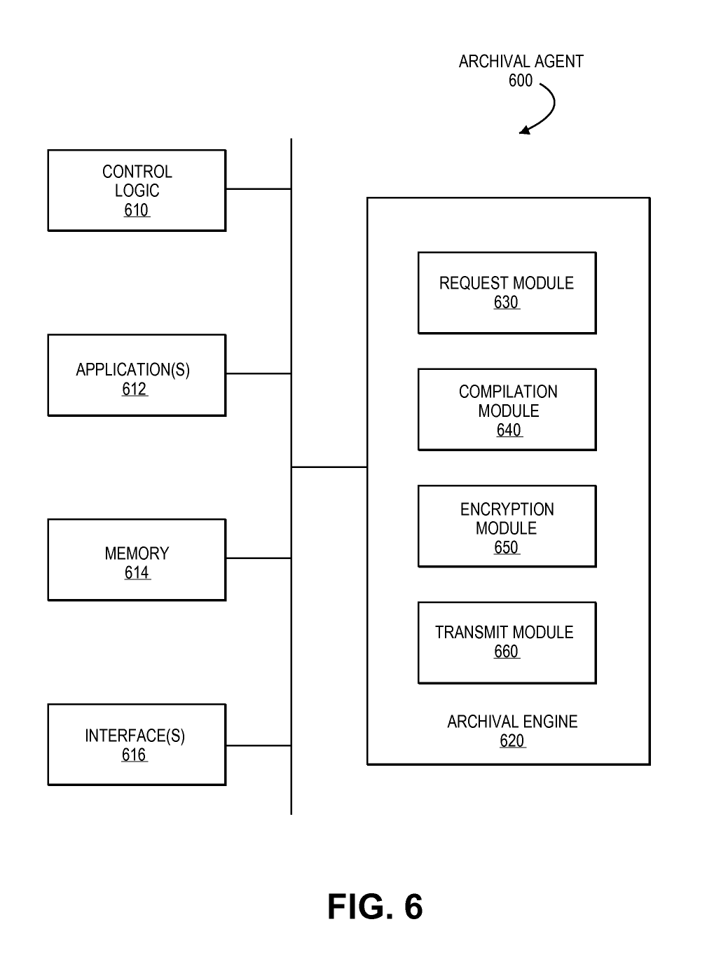

FIG. 6 is a block diagram of one embodiment of an agent that may be utilized to support creation of copies of structured data (e.g., websites) as described herein. The functionality of archival agent 600 can be provided as part of a multitenant database environment, or a non-multitenant database environment.

Archival agent 600 includes control logic 610, which implements logical functional control to direct operation of archival agent 600, and/or hardware associated with directing operation of archival agent 600. Logic may be hardware logic circuits and/or software routines. In one embodiment, archival agent 600 includes one or more applications 612, which represent code sequence and/or programs that provide instructions to control logic 610.

Archivalagent 600 includes memory 614, which represents a memory device and/or access to a memory resource for storing data and/or instructions. Memory 614 may include memory local to archival agent 600, as well as, or alternatively, including memory of the host system on which archival agent 600 resides. In one embodiment, archival agent 600 also includes one or more interfaces 616, which represent access interfaces to/from (an input/output interface) archival agent 600 with regard to entities (electronic or human) external to archival agent 600.

Archival agent 600 also includes archival engine 620, which represents one or more functions or modules that enable archival agent 600 to provide the backup/copy/storage/transmission services as described above. The example of FIG. 6 provides several modules that may be included in archival engine 620; however, different and/or additional modules may also be included.

Example modules that may be involved in providing the functionality described herein include request module 630, compilation module 640, encryption module 650 and transmit module 660. Additional modules not illustrated may also be included to provide additional/different functionality. Each of these modules may further include other sub-modules to provide other functions. As used herein, a module refers to routine, a subsystem, logic circuit, microcode, etc., whether implemented in hardware, software, firmware or some combination thereof.

Request module 630 operates to receive requests for a copy of structured data (e.g., a website). Request module 630 can operate to determine if the request is valid and from an authorized source. For example, in a multitenant database environment, request module 630 can determine if the request is from a tenant having authority to copy/modify the structured data. Further request module 630 can determine if the user has a sufficient privilege level to copy/modify the structured data.

Compilation module 640 operates to gather and compile the data necessary to create the copy of the structured data. As described above, the resulting complication can include content as well as other organizational/formatting/backend/etc. data that makes the content functional. In one embodiment, some or all of the content is not encrypted while some or all of the content as well as the organizational/formatting/backend/etc. data are encrypted. Thus, the resulting file can be partially encrypted.

Encryption module 650 operates to encrypt some or all of the compiled data. In one embodiment, only a portion of the file is encrypted and in other embodiments the complete file can be encrypted. Any encryption technology known in the art can be utilized by encryption module 650.

Transmit module 660 operates to transmit the file to a selected destination. The destination can be, for example, the requesting device, a pre-selected destination, a destination designated by the request, etc. Various transport mechanisms can be utilized to transmit the file.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method for handling data, the method comprising:
generating a collection of data, in response to a request, that includes at least a first portion of user content and a second portion of metadata;
transmitting the collection of data as a file.

2. The method of claim 1 wherein the first portion is not encrypted and the second portion is encrypted.

3. The method of claim 1 wherein the collection of data represents a website.

4. The method of claim 3 wherein the website is hosted by a remote on-demand system.

5. The method of claim 4 wherein the file is transmitted to a test/debug environment.

6. An article comprising a non-transitory computer readable medium having stored thereon instructions for handling data that, when executed, cause one or more processors to:
generate a collection of data, in response to a request, that includes at least a first portion of user content and a second portion of metadata;
transmit the collection of data as a file.

7. The article of claim 6 wherein the first portion is not encrypted and the second portion is encrypted.

8. The article of claim 6 wherein the collection of data represents a website.

9. The article of claim 8 wherein the website is hosted by a remote on-demand system.

10. The article of claim 9 wherein the file is transmitted to a test/debug environment.

11. An apparatus for handling data, the method comprising:
means for generating a collection of data, in response to a request, that includes at least a first portion of user content and a second portion of metadata;
means for transmitting the collection of data as a file.

12. A system for handling data in a remote on-demand system, the system comprising:
a processor;
code stored in memory coupled to the processor; and
the code, when executed on a processor:
allows user access to web data stored in the remote on-demand system;
imports and storing the web data to a local storage location as an executable file;
uses the web data for further processing, handling, management and implementation of a website; and
exports the processed web data to a remote system.

13. The system of claim 12 wherein the first portion of the executable file is not encrypted and the second portion of the executable file is encrypted.

14. The system of claim 13 wherein the website is hosted by a remote on-demand system.

15. The system of claim 14 wherein the executable file is transmitted to a test/debug environment.
